(19) United States
(12) Patent Application Publication
(10) Pub. No.: US 2015/0212192 A1
(43) Pub. Date: Jul. 30, 2015

(54) AUTOMATIC GEO-REFERENCE ERROR CORRECTION FOR CROWDSOURCING SERVICES

(71) Applicant: QUALCOMM Incorporated, San Diego, CA (US)

(72) Inventors: Yin CHEN, Santa Clara, CA (US); Ravi Palanki, Cupertino, CA (US); Hui Chao, San Jose, CA (US)

(73) Assignee: QUALCOMM Incorporated, San Diego, CA (US)

(21) Appl. No.: 14/167,796

(22) Filed: Jan. 29, 2014

(51) Int. Cl. G01S 5/02; H04W 4/02

(52) U.S. Cl. CPC G01S 5/0252; G01S 5/0236; H04W 4/021

(57) ABSTRACT

Systems, methods, and devices are described for reducing error in geo-reference data. One embodiment estimates a plurality of distortion error values corresponding to a first set of geo-reference data based on one or more map constraints, generates a second set of geo-reference data by correcting the distortion error values in the first set of geo-reference data, and estimating an offset value corresponding to the second set of geo-reference data using a position determination technique. The offset value may be used to reduce systematic error in the second set of geo-reference data.

### TECHNICAL FIELD

The present disclosure generally relates to correcting errors in geo-reference data, and in particular, to correcting distortion error and/or systematic error in the geo-reference data.

### BACKGROUND

Position of a mobile device, such as a cellular telephone, smart phone, etc., may be estimated based on information gathered from various systems. One such system may comprise a Global Navigation Satellite System (GNSS), which is one example of a satellite positioning system (SPS). SPS systems may include a number of space vehicles (SV) orbiting the earth. Another example of a system that may provide a basis for estimating the position of a mobile device is a cellular communication system including a number abase stations that communicate with a number of mobile devices. Yet another example is a wireless local area network (WLAN) system including a number of access points (APs) that communicate with a number of mobile devices.

A position estimate, which may also be referred to as a position “fix” for a mobile device, may be obtained based at least in part on distances or ranges from the mobile device to one or more transmitters, and also based at least in part on the locations of the one or more transmitters. As an example, such transmitters may comprise SVs in the case of an SPS, terrestrial base stations in the case of a cellular communications system and/or APs in case of a WLAN system. Ranges to the transmitters may be estimated based on signals transmitted by the transmitters and received at the mobile device. The location of the transmitters may be ascertained, in at least some cases, based on the identities of the transmitters, and the identities of the transmitters may be ascertained from signals received from the transmitters.

Different techniques for obtaining a position fix for a mobile device may be appropriate under different conditions. In an outdoor environment, satellite-based approaches may be suitable, because the mobile device may be able to receive satellite-based positioning signals with specific timing characteristics. Based on reception of such satellites signals, a position fix for the mobile device may be calculated. However, satellite-based approaches are not preferred in indoor environments, because these satellite signals cannot always be received or accurately measured indoors.

In indoor environments, such as a shopping mall, airport, sports arena, convention center etc., terrestrial-based approaches making use of signals transmitted from cellular base stations and/or WLAN access points are generally more useful for obtaining an accurate location fix for a mobile device. The mobile device observes and/or measures signals sent from BSs and/or APs, which may be at known locations. Different types of observations may be obtained such as RSSI (Received Signal Strength indication) and RTT (Round-trip signal propagation Time). Such observations may allow the mobile device or a separate location server to estimate the distance of the mobile device to each BS and/or AP. Trilateration may then be performed to estimate the location of the mobile device, based on the distances to different BSs and/or APs and the known locations of the BSs and/or APs. In another example, the mobile device may compare the measured signal strength from each BS or AP to a grid of data (also known as a heat map) providing the expected signal strength from each BS or AP at different locations. The mobile device may then determine its location, using a process such as pattern matching, by finding a particular location for which the expected signal strengths for a numbers of BSs and/or APs most closely match the signal strengths measured by the mobile device.

Heat map information corresponding to each BS and/or AP may be collected using different techniques. For example, a dedicated device may be used to measure signal strength at certain locations and send the measured data to a location server. The location server may store the heat map information corresponding to each BS and/or AP and provide this information to mobile devices and/or any other fixed devices. In another method, a crowd-sourcing scheme may be used to generate the heat-map information. For example, one or more mobile devices that participate in crowdsourcing record data tuples including SPS coordinates, WiFi, and other sensor measurements. The mobile devices transfer the recorded data tuples to the location server. Transformed data tuples may be used to generate a heat map, calculate location of APs, and/or their corresponding channel parameters, etc. The calculated AP locations and parameters may then be used for indoor positioning.

Typically, geo-reference data is used to transform the SPS coordinates to a local coordinate system (e.g., x and y in a two dimensional (2D) coordinate system corresponding to indoor environment of a building). Geo-reference data are usually provided to a device from a third party vendor. Geo-reference data (e.g., the data from Google and Bing maps) may have errors in a range of a few meters. These errors may reduce accuracy of estimated position of a crowd-sourced location service, if not accounted for. In general, a truly accurate geo-reference data source may not exist. On the other hand, accurate geo-reference data is essential for estimating position of devices with high accuracy using crowd.-sourced positioning systems. Therefore, there is a need for a method to estimate and/or correct errors in geo-reference data.

### SUMMARY

Certain embodiments provide a method for reducing error in geo-reference data. The method generally includes, in part, estimating a plurality of distortion error values corresponding to a first set of geo-reference data based on one or more map constraints, generating a second set of geo-reference data by correcting the plurality of distortion error values in the first set of geo-reference data, and estimating an offset value corresponding to the second set of geo-reference data using a position determination technique.

Certain embodiments provide an apparatus for reducing error in geo-reference data. The apparatus generally includes, in part, means for estimating a plurality of distortion error values corresponding to a first set of geo-reference data based on one or more map constraints, means for generating a second set of geo-reference data by correcting the plurality of distortion error values in the first set of geo-reference data, and means for estimating an offset value corresponding to the second set of geo-reference data using a position determination technique.

Certain embodiments provide an apparatus for reducing error in geo-reference data. The apparatus generally includes at least one processor and a memory coupled to the at least one processor. The at least one processor configured to estimate a plurality of distortion error values corresponding to a first set of geo-reference data based on one or more map constraints, generate a second set of geo-reference data by correcting the plurality of distortion error values in the first set of geo-reference data, and estimate an offset value corresponding to the second set of geo-reference data using a position determination technique.

Certain embodiments provide a non-transitory processor-readable medium for reducing error in geo-reference data. The processor-readable medium may include, in part, processor-readable instructions configured to cause a processor to estimate a plurality of distortion error values corresponding to a first set of geo-reference data based on one or more map constraints, generate a second set of geo-reference data by correcting the plurality of distortion error values in the first set of geo-reference data, and estimate an offset value corresponding to the second set of geo-reference data using a position determination technique.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example satellite positioning system and a terrestrial network in communication with a mobile device, in accordance with certain embodiments of the present disclosure.

FIGS. 2A and 2B illustrate example differences in geo-reference data provided by Google maps and Bing maps.

FIG. 3 illustrates example errors in AP locations due to geo-reference error, in accordance with certain embodiments of the present disclosure.

FIG. 4 illustrates example systematic errors in geo-reference data, in accordance with certain embodiments of the present disclosure.

FIG. 5 illustrates example distortion errors in geo-reference data, in accordance with certain embodiments of the present disclosure.

FIG. 6 illustrates an example method for correcting local distortion errors, in accordance with certain embodiments of the present disclosure.

FIGS. 7A and 7B illustrate two example routes estimated with different positioning methods, in accordance with certain embodiments of the present disclosure.

FIG. 8 illustrates example operations that may be performed to correct errors in geo-reference data, in accordance with certain embodiments of the present disclosure.

FIG. 9 illustrates one potential implementation of a device which may be used to correct errors in geo-reference data, in accordance with certain embodiments of the present disclosure.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure.

However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are used interchangeably in some contexts. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATS) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.1 lx network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground-based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MS AS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, the term “base station” includes any wireless communication station and/or device, typically installed at a fixed terrestrial location and used to facilitate communication in a wireless communications system. For example, a base station may comprise a cellular network base station, a wireless local area network (WLAN) access point, Macro cell, Macro base station, Pico cell, Pico base station, Femto cell, Femto base station, eNode B, Node B, or the like.

As used herein, the term “mobile device” refers to a device that may from time to time have a position location that changes. For example, a mobile device may comprise a cellular telephone, wireless communication device, user equipment, laptop computer, a personal communication system (PCS) device, personal digital assistant (PDA), personal audio device (PAD), portable navigational device, and/or other portable communication devices.

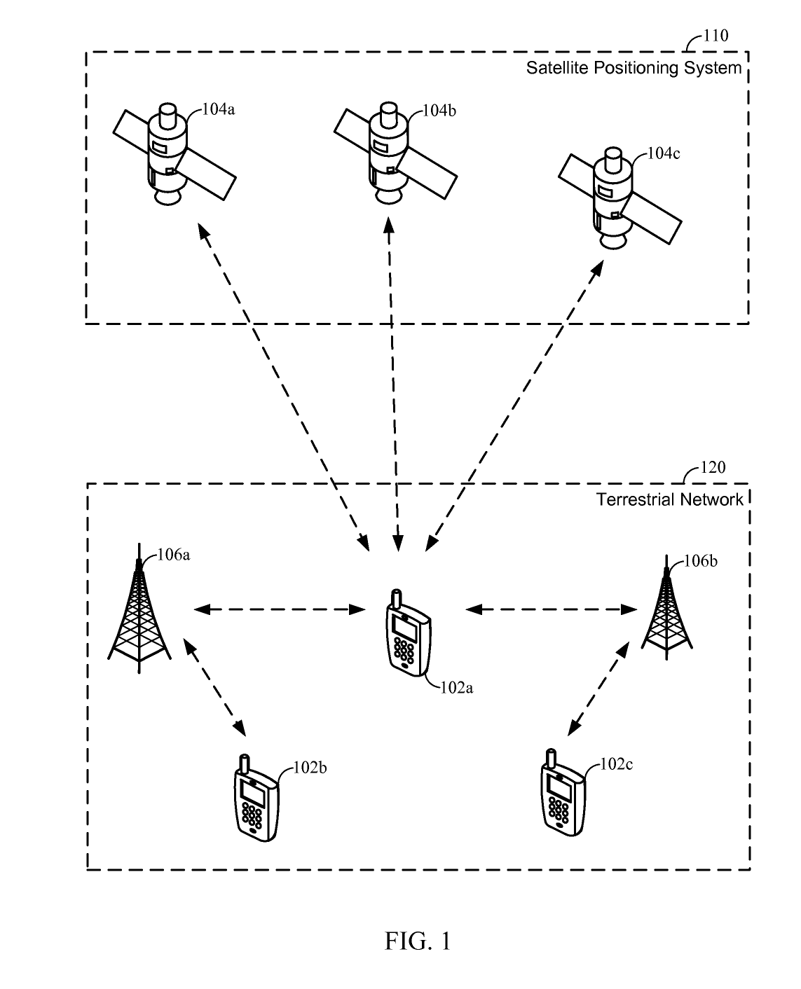

FIG. 1 illustrates an example satellite positioning system 110 and a terrestrial network 120 in communication with a mobile device, in accordance with certain embodiments of the present disclosure. Satellite positioning system 110 may comprise a number of SVs, for example SVs 104a, 104b, and 104c. The satellite positioning system 110 may comprise one or more satellite positioning systems, such as GPS, GNSS, and/or Galileo, and the like. Mobile devices 102a, 102b, and 102c may receive signals from one or More of SVs 104a, 104b, and 104c, and may communicate with one or more base stations 106a and/or 106b.

Terrestrial network 120 may provide voice and/or data communication for a number of mobile devices including mobile device 102a, for example, and may further support position estimation for the mobile devices in addition to providing voice/data service. Terrestrial network 120 may comprise any of a number of cellular network types (such as CDMA, LTE, WiMAX, and the like) and/or WLAN network types (e.g., Wi-Fi and the like). Terrestrial network 120 may include base stations 106a and 106b that provide communication for a number of wireless terminals such as mobile devices 102a-102c.

For simplicity, only two base stations 106a and 106b and only three mobile devices are depicted in FIG. 1. However, other examples may include any number of mobile devices and/or base stations. Also, terrestrial network 120 is merely an example wireless communications system, and the scope of claimed subject matter is not limited in this respect.

In one example, mobile device 102a may obtain one or more measurements from one or more signals received from one or more of the SVs and/or base stations. Mobile device 102 may calculate a position location for itself based, at least in part, on timing parameters received through communication with one or more of base stations 106a and 106b, and further based, at least in part, on known position locations of the base stations. The mobile device may also make use of an estimated propagation delay for signals received from a base station source, a satellite source or both.

In an embodiment, a network entity such as, for example, a location server (not shown), may receive information from different devices in the network and store them in a database. In addition, the location server can determine position of different devices. Such a determination may be based, at least in part, on information gathered by the mobile devices 102 from one or more of the base stations 106a and 106b and/or SVs. The location server may transmit the calculated position location and other parameters to one or more of the mobile devices and/or base stations.

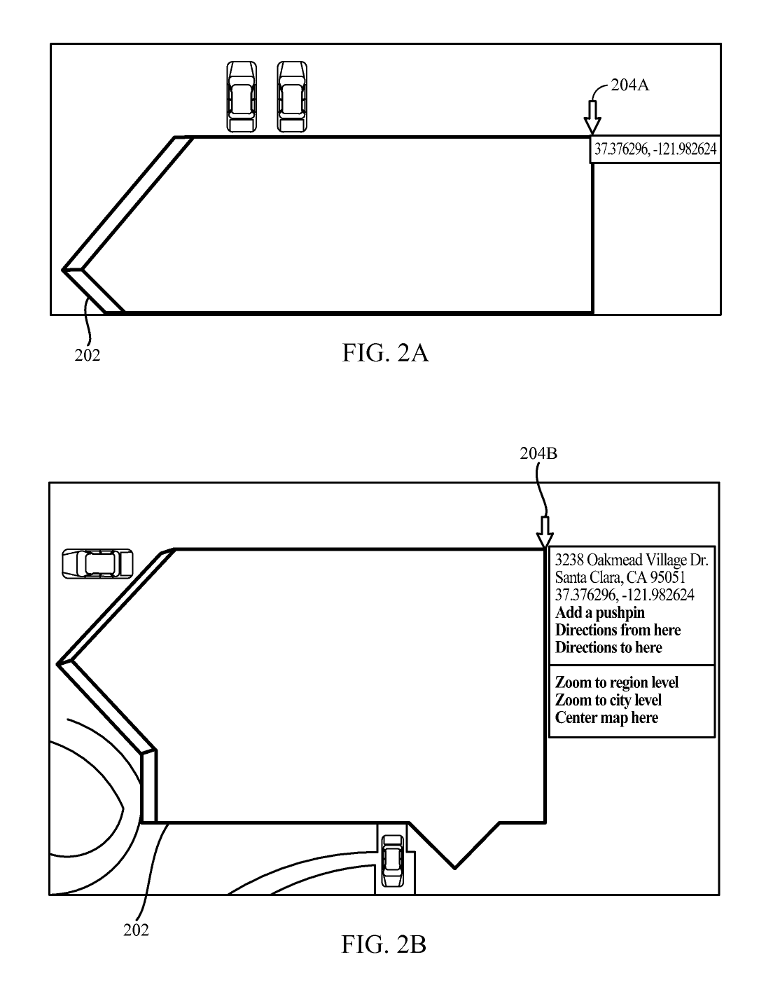

Geo-reference data may be used to transform global coordinates of a device (e.g., coordinates determined using a SPS network) to a local coordinate system (e.g., x and y in a two-dimensional coordinate system corresponding to indoor environment of a building). Geo-reference data may be obtained from a third party vendor, or can be measured directly by a highly accurate measuring device. Geo-reference data provided by third party vendors (e.g., Google Maps and/or Bing Maps) may have errors in a range of a few meters (as illustrated in FIG. 2). These errors, if not corrected, may reduce accuracy of estimated position in a crowd-sourced location service. Another option would be to measure the geo-reference data with highly accurate measuring devices for each building/venue of interest. However, this method is very costly and is not scalable. In general, a truly accurate geo-reference data source may not exist. On the other hand, accurate geo-reference data is essential for estimating position of devices with high accuracy using crowd-sourcing positioning systems.

Certain embodiments provide methods for estimating and/or correcting errors in geo-reference data. In one embodiment, distortion error in geo-reference, data may be estimated based on one or more map constraints (e.g., shape of a building, and the like). In addition, systematic error (e.g., bias) in the geo-reference data may be estimated using different positioning methods.

FIGS. 2A and 2B illustrate example differences in geo-reference data provided by two different vendors. These figures mean to illustrate satellite images that are taken from the same building using different satellites, at different times or with different angles. FIG. 2A illustrates a building 202 in a satellite image provided by Google maps. Coordinates of a corner 204A of the building 202 is shown as (37.376296, −121.982624) in the Google maps.

FIG. 2B illustrates the same building 202 in another satellite image provided by Bing maps. Coordinates of the same corner (e.g., 204B) of the building 202 is shown as (37.376293, −121.982672) in the Bing maps. Comparing the coordinates provided by each of these two vendors shows an offset of proximately 4.3 meters. Therefore, at least one of these coordinates should be in error. If the error in the geo-reference coordinates provided by Google maps and/or Bing maps is not corrected, the error may translate into a positioning error (e.g., approximately 4.3 meters) in the crowdsourcing positioning system.

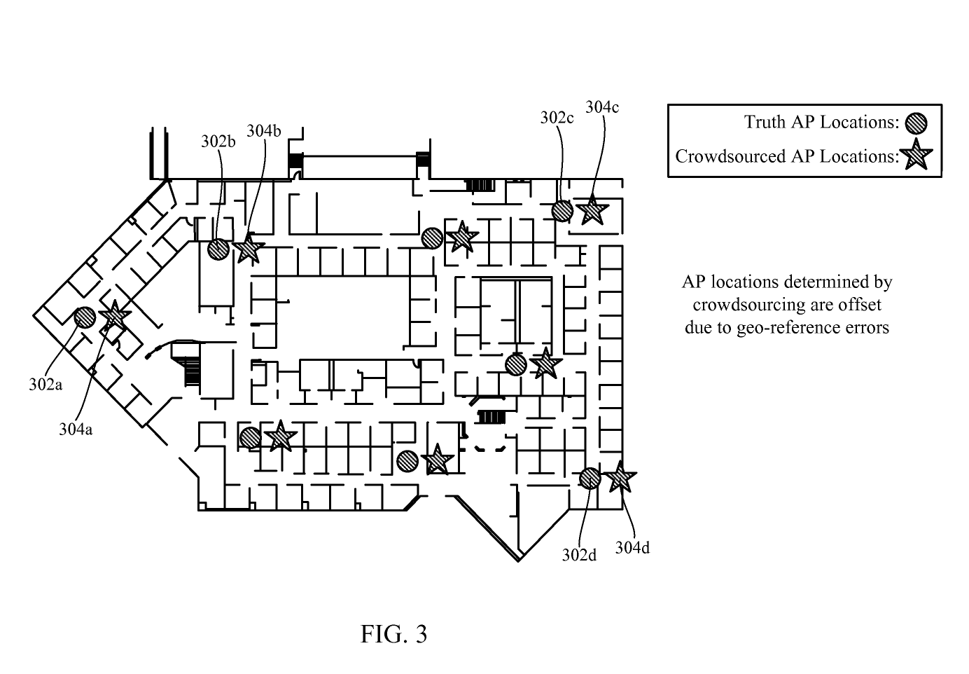

FIG. 3 illustrates example errors in estimated location of a set of APs due to geo-reference error, in accordance with certain embodiments of the present disclosure. In this figure, the APs are located at positions 302a, 302b, 302c, 302d, etc. However, position of the APs is estimated (e.g., using crowd-sourcing) to be in 304a, 304b, 304c, 304d, etc. As illustrated, there is a difference between the actual position of each the APs and the estimated position of the APs (e.g., the estimation error). Part of the estimation error is caused by the errors in the geo-reference data that is used as an input to the estimation method.

In general, geo-reference data may include at least two types of error, such as systematic error and/or distortion error. Systematic error may refer to the errors that are common between a set of data points. For example, if some or all of the data points have a constant bias compared to the actual values, the amount of bias is the systematic error. For example, considering a building with a square shape, the systematic error may result in a shift in the geo-reference coordinates corresponding to each corner of the building (e.g., shift k units to east and/or west). On the other hand, distortion error may refer to the errors that are not simple shifts and may even be random in nature. For example, the distortion errors may result in a distortion in the shape of the building. As an example, coordinates corresponding to each corner of the building may include some random errors, which may result in adjacent walls not being perpendicular to each other.

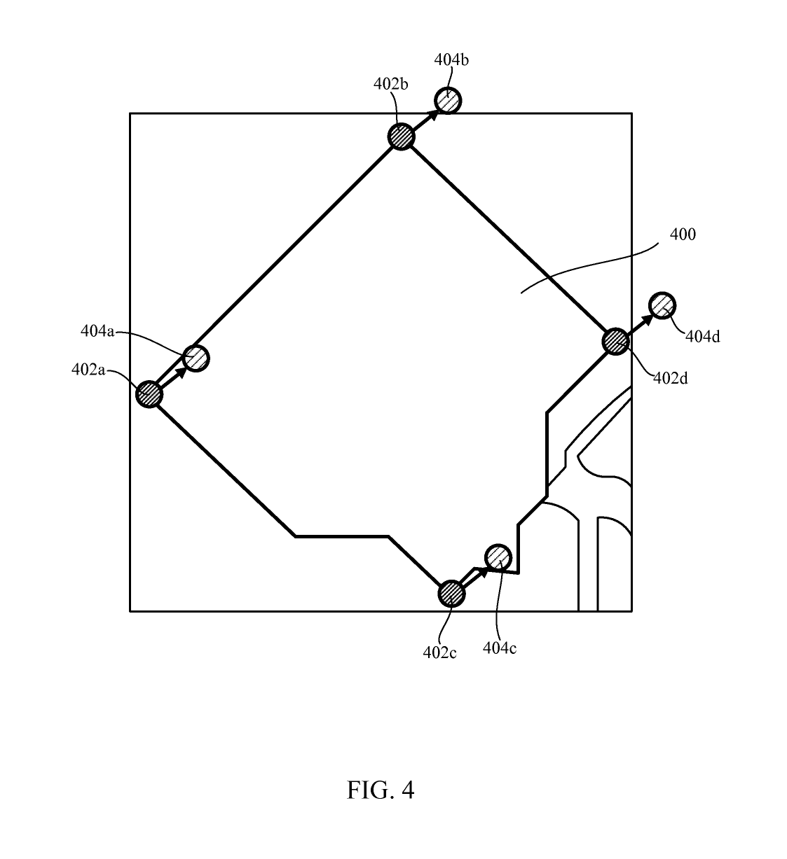

FIG. 4 illustrates example systematic errors (e.g., bias) in a set of data, in accordance with certain embodiments of the present disclosure. In this figure, points 402a, 402b, 402c and 402d illustrate actual corners of a building on a map. Points 404a, 404b, 404c and 404d show a set of data corresponding to each of these corners that include systematic bias. As can be seen, the data includes a common bias (e.g., offset) for all the data points. For example, each corner of the building is shifted towards top-right corner of the map.

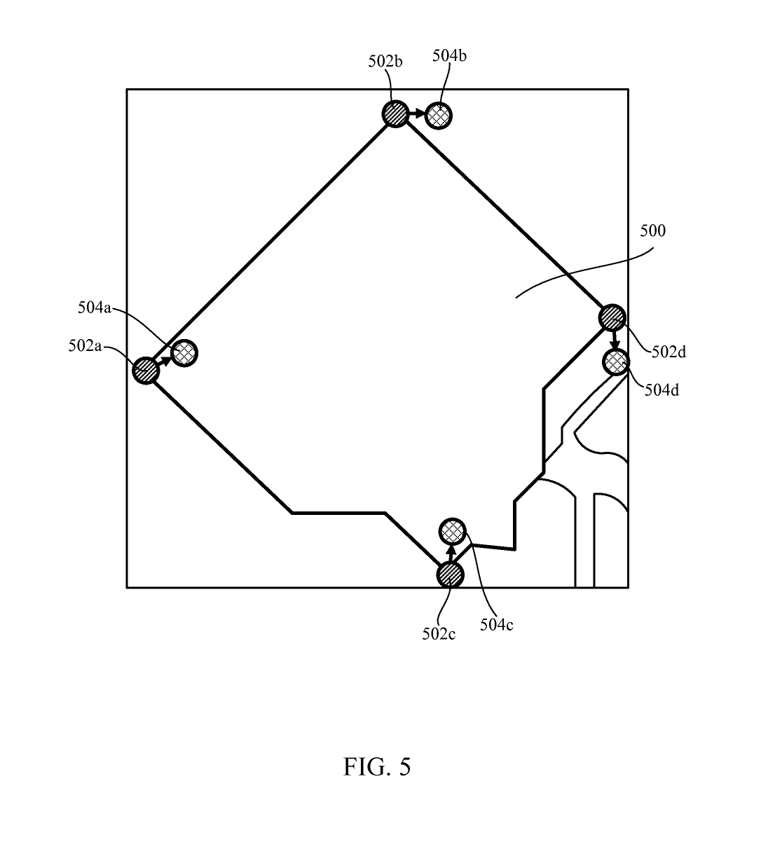

FIG. 5 illustrates example distortion errors in a set of data, in accordance with certain embodiments of the present disclosure. In this figure, points 502a, 502b, 502c and 502d illustrate actual corners of a building 500 on a map. Points 504a, 504b, 504c and 504d show a set of data corresponding to each of these corners that include distortion error. As can be seen, the data includes random errors corresponding to each corner of the building. These random errors may result in a distortion in the shape of the building (e.g., walls not being perpendicular to each other, etc.). In one embodiment, distortion errors in the geo-reference data can be estimated and corrected using knowledge of the geometric shape of the building (e.g., floor plan of the building).

Certain embodiments of the present disclosure present methods for automatically correcting geo-reference errors using map constraints. In one embodiment, any “obvious” geo-reference distortion error may be corrected using certain map constraints. For example, building corners should form certain shapes with respect to each other. As an example, most of the buildings have perpendicular walls. Therefore, if two walls in a building show an angle of 88 degrees (instead of 90 degrees) with respect to each other, the difference is most likely because of distortion error in the data. In another example, a floor plan of the building of interest may be available. Based on the floor plan, specific angles between walls, and other constraints corresponding to the shape of the building can be applied to the geo-reference data to correct the distortion errors.

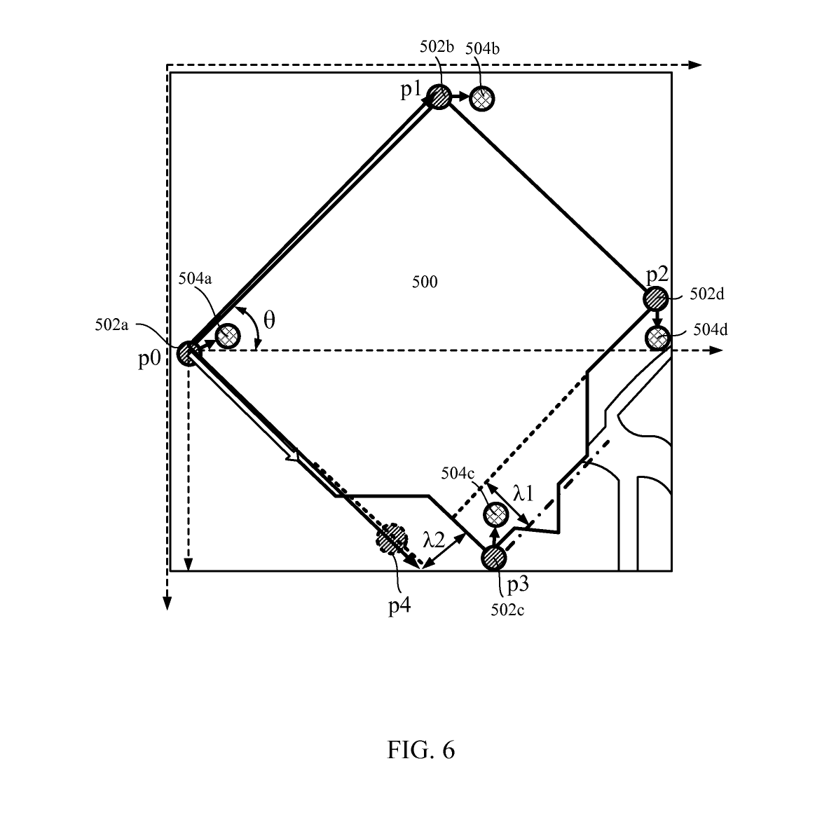

FIG. 6 illustrates an example method for correcting local distortion in geo-reference data, in accordance with certain embodiments of the present disclosure. In one embodiment, distortion errors may be corrected using a linear constraint solver. In addition, orientation and scale of the map can be inferred by analyzing the data. For example, one or more constraints may be defined based on the shape of the building 500.

In one embodiment, if orientation of the building is not known, range of rotation of the data points in the geo-reference data can be estimated based on the given geo-reference data points. For example, a minimum and a maximum value for the rotation of the data points may be defined as follows:

$$θ ∈ [ min ( atan \frac{{p}_{1} \cdot y - {p}_{0} \cdot y}{{p}_{1} \cdot x - {p}_{0} \cdot x} , - atan \frac{{p}_{1} \cdot y - {p}_{2} \cdot y}{{p}_{1} \cdot x - {p}_{2} \cdot x} ) - 5 , \\ max ( atan \frac{{p}_{1} \cdot y - {p}_{0} \cdot y}{{p}_{1} \cdot x - {p}_{0} \cdot x} , - atan \frac{{p}_{1} \cdot y - {p}_{2} \cdot y}{{p}_{1} \cdot x - {p}_{2} \cdot x} ) + 5 ]$$

in which a tan(.) represents arctangent function, min represents a minimum function, and max represents a maximum function.

For each θ, all the points pᵢ may be rotated with rotation matrix R to correspond to a new coordinate system, as follows:

$${p}_{i}^{′} = R \times {p}_{i} , \\ R = [ \begin{matrix}cos θ & - sin θ \\ sin θ & cos θ\end{matrix} ] .$$

In one embodiment, several constraints may be defined for one or more subsets and/or the whole set of geo-reference data. It should be noted that only a few examples are mentioned here, however, this list is by no means comprehensive, and any other constraint may be used to estimate and correct distortion errors in the geo-reference data.

In one embodiment, one or more relations may be inferred between data points. For example, based on the shape of the building 500 in FIG. 6, the following constraints may be defined to determine coordinates of p₄ based on p₃, λ₁and λ₂:

p₄. x=p₃. x−λ₂, and

p₄. y=p₃. y−λ₁.

For certain embodiments, one or more angular constraints may be defined for one or more data points. For example, a building may be considered to have perpendicular walls. In the example shown in FIG. 6, the following constraints can be defined:

$$\frac{{p}_{1} \cdot x - {p}_{0} \cdot x}{{p}_{1} \cdot y - {p}_{0} \cdot y} = - \frac{{p}_{1} \cdot y - {p}_{2} \cdot y}{{p}_{1} \cdot x - {p}_{2} \cdot x} ;$$

$$\frac{{p}_{0} \cdot x - {p}_{1} \cdot x}{{p}_{0} \cdot y - {p}_{1} \cdot y} = - \frac{{p}_{0} \cdot y - {p}_{4} \cdot y}{{p}_{0} \cdot x - {p}_{4} \cdot x} ;$$

$$\frac{{p}_{2} \cdot x - {p}_{1} \cdot x}{{p}_{2} \cdot y - {p}_{1} \cdot y} = - \frac{{p}_{2} \cdot y - {p}_{4} \cdot y}{{p}_{2} \cdot x - {p}_{4} \cdot x} .$$

For certain embodiments, one or more dimensional constraints may be defined for a building or a venue corresponding to an area of interest in geo-reference data. For example, if depth of the building 500 is known, the following constraint may be defined:

dist(p₁, p₂)=dist(p₀, p₄)=building_depth.

Similarly, if width of the building 500 is known, the following constraint may be defined:

dist(p₀, p₁)=dist(p₂, p₄)=building_width.

For certain embodiments, in addition to the above constraints, a cost function may be defined to minimize the overall changes made to geo-reference points, as follows:

Σᵢ₌₀ⁿ(|Δpᵢ|)or Σᵢ₌₀ⁿ(Δpᵢ)²

In general, one or more of the map constraints (as described above) may be used as inputs to a linear constraint solver to determine distortion errors corresponding to one or more of the data points in the goo-reference data. The error may then be applied to the geo-reference data to correct the distortion errors. For example, the determined errors may be subtracted from each of the data points to reduce the errors in the geo-reference data.

After correcting the distortion error, certain embodiments estimate and correct systematic error in a set of geo-reference data. As described earlier, in a crowd-sourcing system, one or more mobile devices may collect data tuples. For example, the mobile devices may collect information about signals, and other terrestrial signals received from different transmitters at different locations. In addition, if any of the mobile devices receives SPS signals, the mobile device collects signals from one or more SVs in the SPS network, in addition to the Wi-Fi signals. As an example, a set of mobile devices may be inside a building, without access to SPS signals. These mobile devices may measure Wi-Fi signals. In addition, some of the mobile devices may be outside of the building, and/or close to windows of the building, which can receive both SPS and Wi-Fi signals. These mobile devices may measure SPS signals, Wi-Fi signals, and/or other signals and send their measurements to a location server. In addition, each of the mobile device may measure other parameters (e.g., time, temperature, etc.) and send its measurements to the server.

Without loss of generality, it can be assumed that at least some of the mobile devices are able to measure global coordinates (e.g., SPS signals). For example, these mobile devices may be close to the windows and receive SPS signals through the windows. In one embodiment, the mobile devices that have access to both local data (e.g., Wi-Fi measurements) and global data (e.g., satellite measurements), may act as anchor points to relate data associated with local coordinates and the data associated with global coordinates.

In one embodiment, the location server receives data from a plurality of mobile devices and learns and/or calculates location of one or more transmitters (e.g., APs) in terms of global coordinates. In addition, the location server may calculate one or more parameters associated with each transmitter. For example, the serve may calculate transmission power of each transmitter, processing delay associated with each transmitter, and other parameters.

In one embodiment, a mobile device may collect information on a specific route. For example, a user holding the mobile device may walk in a hallway of a building and collect data (e.g., signals received from each of the transmitters in the area). For example, the mobile device may collect data corresponding to signals received from each of the APs in the building over multiple points on the route. In addition, the mobile device may collect other sensor measurements on the specified route.

In one embodiment, the mobile device may perform mobile-based positioning (MBP) using the collected data. Alternatively, the mobile device may send the data to the location server and let the location server perform network-based positioning (NBP). The mobile device or the server may compare and map a trajectory found by MBP and/or NBP to the routable regions on a map (e.g., floor plan of the building). The offset between the trajectory and a feasible route found by mapping is an estimation of the geo-reference systematic error.

If the mobile device performs MBP, the mobile device sends the estimated systematic error value to the location server to correct the geo-reference data. Alternatively, if the server performs NBP, the server sends the estimated systematic error value to the mobile devices.

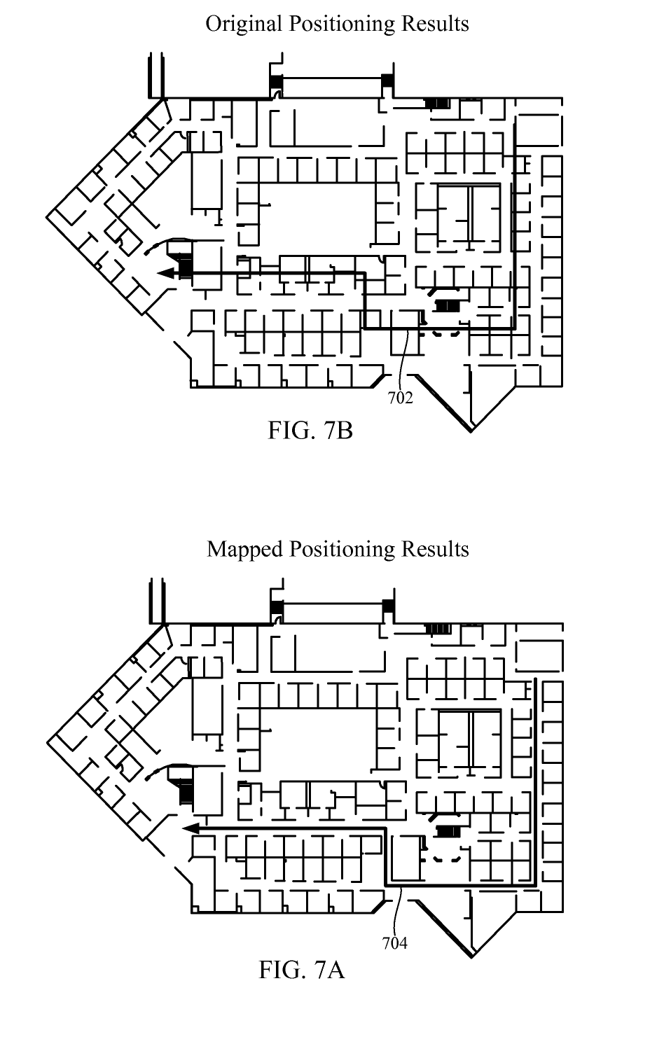

FIGS. 7A and 7B illustrate results of two example positioning methods, in accordance with certain embodiments of the present disclosure. FIG. 7A illustrates a route 702 that is estimated using the data collected over the specified route and the original positioning information. The original positioning information refers to the location of the transmitters (e.g., access points) based on geo-reference data in which systematic errors are not corrected. As can be seen, the estimated route passes through walls, which is not feasible. FIG. 7B illustrates another route 704 which is determined by flapping the positioning results into the routable regions on the map. The offset between the two routes 702 and 704 is the systematic geo-reference error.

It should be noted that in general, the estimated offset may be unique for each mobile device. In order to estimate the systematic error more accurately, the above procedure may be performed with multiple mobile devices and the systematic error may be considered as an average of different estimations. In another embodiment, bias or systematic error in signals received from different SPS networks may be considered in the estimation to increase accuracy of the estimation.

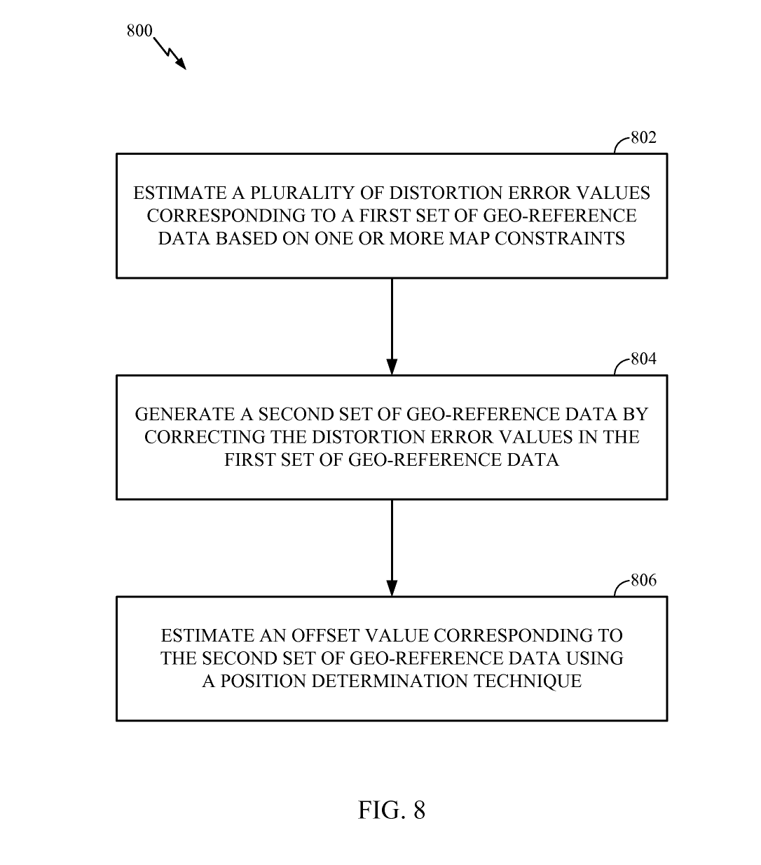

FIG. 8 illustrates example operations that may be performed by a device to correct errors in geo-reference data, in accordance with certain embodiments of the present disclosure. At 802, the device estimates a plurality of distortion error values corresponding to a first set of geo-reference data based on one or more map constraints. In one embodiment, the one or more map constraints correspond to shape of one or more objects (e.g., floor plan of a building, etc.) At 804, the device generates a second set of geo-reference data by correcting the distortion error values in the first set of geo-reference data. At 806, the device estimates an offset value corresponding to the second set of geo-reference data using a position determination technique. The device may then apply the offset value to the second set of geo-reference data to reduce error.

In one embodiment, the device estimates the offset value by obtaining location information corresponding to one or more transmitters (e.g., APs) in a global coordinate system. For example, the device may calculate the location information based on signal measurements performed by a plurality of mobile devices. The device may then translate the location information to a set of local transmitter location information (e.g., corresponding to a local coordinate system) using the second set of geo-reference data.

In one embodiment, the device obtains signal measurements corresponding to a plurality of points over a predetermined path. The device determines local coordinates of the plurality of points using the position determination technique based at least on the obtained AP vicinity information (e.g., AP heat map), and the set of local AP location information. The device then determines the offset value by comparing the local coordinates of the plurality of points with one or more possible paths on a local map. For example, if the device is a mobile device, it obtains the AP vicinity information by measuring one or more signals on the plurality of points. In another embodiment, if the device is a server, it receives the AP vicinity information from a mobile device.

In one embodiment, the device obtains information corresponding to a plurality of transmitters on a plurality of points over a predetermined path. The device may then determine local coordinates of the plurality of points using the position determination technique based at least on the obtained information and the set of local transmitter location information. In addition, the device determines the offset value by comparing the local coordinates of the plurality of points with one or more possible paths on a local map.

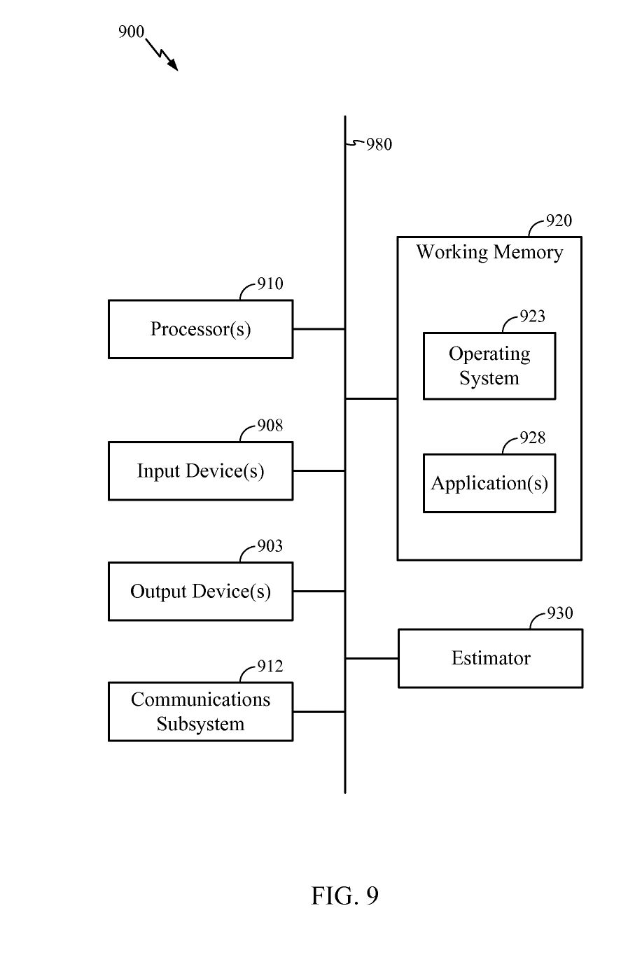

FIG. 9 illustrates one potential implementation of a device which may be used to estimate and/or correct errors in geo-reference data, in accordance with certain embodiments of the present disclosure. In one embodiment, device 102a as described in FIG. 1 may be implemented with the specifically described details of process 800. In the embodiment of device 900 shown in FIG. 9, specialized modules such as estimator 930 may estimate the geo-reference error values. These modules may be implemented to interact with various other modules of device 900. Memory 920 may be configured to store geo-reference data and the estimated distortion and/or systematic error values, and may also store settings and instructions regarding different positioning techniques, etc.

In the embodiment shown at FIG. 9, the device may be a mobile device or a location server and include processor 910 configured to execute instructions for performing operations at a number of components and can be, for example, a general-purpose processor or microprocessor suitable for implementation within a portable electronic device. Processor 910 may thus implement any or all of the specific steps for operating compression module as described herein. Processor 910 is communicatively coupled with a plurality of components within mobile device 900. To realize this communicative coupling, processor 910 may communicate with the other illustrated components across a bus 980. Bus 980 can be any subsystem adapted to transfer data within mobile device 900. Bus 980 can be a plurality of computer buses and include additional circuitry to transfer data.

Memory 920 may be coupled to processor 910. In some embodiments, memory 920 offers both short-term and long-term storage and may in fact be divided into several units. Short term memory may store data which may be discarded after an analysis, or all data may be stored in long term storage depending on user selections. Memory 920 may be volatile, such as static random access memory (SRAM) and/or dynamic random access memory (DRAM) and/or non-volatile, such as read-only memory (ROM), flash memory, and the like. Furthermore, memory 920 can include removable storage devices, such as secure digital (SD) cards. Thus, memory 920 provides storage of computer readable instructions, data structures, program modules, and other data for mobile device 900. In some embodiments, memory 920 may be distributed into different hardware modules.

In some embodiments, memory 920 stores a plurality of applications 928. Applications 928 contain particular instructions to be executed by processor 910. In alternative embodiments, other hardware modules may additionally execute certain applications or parts of applications. Memory 920 may be used to store computer readable instructions for modules that implement positioning techniques according to certain embodiments, and may also store error values as part of a database.

In some embodiments, memory 920 includes an operating system 923. Operating system 923 may be operable to initiate the execution of the instructions provided by application modules and/or manage other hardware modules as well as interfaces with communication modules 912 which may use a wireless transceiver and a link. Operating system 923 may be adapted to perform other operations across the components of mobile device 900, including threading, resource management, data storage control and other similar functionality.

In some embodiments, mobile device 900 includes a plurality of other hardware modules (e.g., estimator 930). Each of these hardware modules is a physical module within mobile device 900. As an example, the estimator 930 may be configured to estimate geo-reference error as described herein.

In certain embodiments, a user may use a user input module 908 to select how to analyze the heat maps. Mobile device 900 may include a component such as a wireless communications module 912 which may integrate an antenna and wireless transceiver with any other hardware, firmware, or software necessary for wireless communications. Such a wireless communication module may be configured to receive signals from various devices such as data sources via networks and base stations such as a network base station. In certain embodiments, calibration information and/or OEM and model number information may be communicated to server computers, other mobile devices, or other networked computing devices to be stored in a remote database and used by multiple other devices when the devices execute positioning functionality

In addition to other hardware modules and applications in memory 920, mobile device 900 may have a display output 903 and a user input module 908. Display output 903 graphically presents information from mobile device 900 to the user. This information may be derived from one or more application modules, one or more hardware modules, a combination thereof, or any other suitable means for resolving graphical content for the user (e.g., by operating system 923). Display output 903 can be liquid crystal display (LCD) technology, light emitting polymer display (LPD) technology, or some other display technology. In some embodiments, display output 903 is a capacitive or resistive touch screen and may be sensitive to haptic and/or tactile contact with a user. In such embodiments, the display output 903 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are giver the description to provide a thorough understanding of the embodiments. However, embodiments may be practiced without certain specific details. For example, well-known circuits, processes, algorithms, structures, and techniques have been mentioned without unnecessary detail in order to avoid obscuring c embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

What is claimed is:

1. A method for reducing error in geo-reference data by a device, comprising:
estimating a plurality of distortion error values corresponding to a first set of geo-reference data based on one or more map constraints;
generating a second set of geo-reference data by correcting the plurality of distortion error values in the first set of geo-reference data; and
estimating an offset value corresponding to the second set of geo-reference data using a position determination technique.

2. The method of claim 1 further comprising:
applying the offset value to the second set of geo-reference data to reduce error.

3. The method of claim 1 wherein the one or more map constraints correspond to shape of one or more objects.

4. The method of claim 1 wherein estimating the offset value comprises:
obtaining location information corresponding to one or more transmitters in a global coordinate system; and
translating the obtained location information to a set of local transmitter location information using the second set of geo-reference data, wherein the set of local AP location information is related to a local coordinate system.

5. The method of claim 4 wherein obtaining the location information comprises calculating the location information based on signal measurements performed by a plurality of mobile devices.

6. The method of claim 4 further comprising:
obtaining information corresponding to a plurality of transmitters on a plurality of points over a predetermined path; determining local coordinates of the plurality of points using the position determination technique based at least on the obtained information and the set of local transmitter location information; and
determining the offset value by comparing the local coordinates of the plurality of points with one or more possible paths on a map.

7. The method of claim 6 wherein the device is a mobile device, and obtaining the information corresponding to the plurality of transmitters comprises collecting the information by measuring one or more signals at the plurality of points.

8. The method of claim 6 wherein the device is a server, and obtaining the information corresponding to the plurality of transmitters comprises receiving the information from a mobile device.

9. An apparatus for reducing error in geo-reference data, comprising:
means for estimating a plurality of distortion error values corresponding to a first set of geo-reference data based on one or more map constraints;
means for generating a second set of geo-reference data by correcting the plurality of distortion error values in the first set of geo-reference data; and
means for estimating an offset value corresponding to the second set of geo-reference data using a position determination technique.

10. The apparatus of claim 9 further comprising:
means for applying the offset value to the second set of geo-reference data to reduce error.

11. The apparatus of claim 9 wherein the one or more map constraints correspond to shape of one or more objects.

12. The apparatus of claim 9 wherein the means for estimating the offset value comprises:
means for obtaining location information corresponding to one or more transmitters in a global coordinate system; and
means for translating the obtained location information to a set of local transmitter location information using the second set of geo-reference data, wherein the set of local AP location information is related to a local coordinate system.

13. The apparatus of claim 12 wherein the means for obtaining the location information comprises means for calculating the location information based on signal measurements performed by a plurality of mobile devices.

14. The apparatus of claim 12 further comprising:
means for obtaining information corresponding to a plurality of transmitters on a plurality of points over a predetermined path;
means for determining local coordinates of the plurality of points using the position determination technique based at least on the obtained information and the set of local transmitter location information; and
means for determining the offset value by comparing the local coordinates of the plurality of points with one or more possible paths on a map.

15. The apparatus of claim 14 wherein the apparatus is a mobile device, and the means for obtaining the information corresponding to the plurality of transmitters comprises the means for collecting the information by measuring one or more signals at the plurality of points.

16. The apparatus of claim 14 wherein the apparatus is a server, and the means for obtaining the information corresponding to the plurality of transmitters comprises the means for receiving the information from a mobile device.

17. An apparatus for reducing error in geo-reference data, comprising:
at least one processor configured to:
estimate a plurality of distortion error values corresponding to a first set of geo-reference data based on one or more map constraints,
generate a second set of geo-reference data by correcting the plurality of distortion error values in the first set of geo-reference data, and
estimate an offset value corresponding to the second set of geo-reference data using a position determination technique; and
a memory coupled to the at least one processor.

18. The apparatus of claim 17 wherein the at least one processor is further configured to:
apply the offset value to the second set of geo-reference data to reduce error.

19. The apparatus of claim 17 wherein the one or more map constraints correspond to shape of one or more objects.

20. The apparatus of claim 17 wherein the at least one processor is further configured to obtain location information corresponding to one or more transmitters in a global coordinate system; and
translate the obtained location information to a set of local transmitter location information using the second set of geo-reference data, wherein the set of local AP location information is related to a local coordinate system.

21. The apparatus of claim 20 wherein the at least one processor is further configured to calculate the location information based on signal measurements performed by a plurality of mobile devices.

22. The apparatus of claim 20 wherein the at least one processor is further configured to obtain information corresponding to a plurality of transmitters on a plurality of points over a predetermined path;
determine local coordinates of the plurality of points using the position determination technique based at least on the obtained information and the set of local transmitter location information; and
determine the offset value by comparing the local coordinates of the plurality of points with one or more possible paths on a map.

23. The apparatus of claim 22 wherein the apparatus is a mobile device, and wherein the at least one processor is further configured to collect the information by measuring one or more signals at the plurality of points.

24. The apparatus of claim 22 wherein the apparatus is a server, and wherein the at least one processor is further configured to receive the information from a mobile device.

25. A non-transitory processor-readable medium for reducing error in geo-reference data, comprising processor-readable instructions configured to cause a processor to:
estimate a plurality of distortion error values corresponding to a first set of geo-reference data based on one or more map constraints;
generate a second set of geo-reference data by correcting the plurality of distortion error values in the first set of geo-reference data; and
estimate an offset value corresponding to the second set of geo-reference data using a position determination technique.

26. The non-transitory processor-readable medium of claim 25 wherein the processor-readable instructions is further configured to cause the processor to:
apply the offset value to the second set of geo-reference data to reduce error.

27. The non-transitory processor-readable medium of claim 25 wherein the one or more map constraints correspond to shape of one or more objects.

28. The non-transitory processor-readable medium of claim 25 wherein the processor-readable instructions is further configured to cause the processor to:
obtain location information corresponding to one or more transmitters in a global coordinate system; and
translate the obtained location information to a set of local transmitter location information using the second set of geo-reference data, wherein the set of local AP location information is related to a local coordinate system.

29. The non-transitory processor-readable medium of claim 28 wherein the processor-readable instructions is further configured to cause the processor to:
calculate the location information based on signal measurements performed by a plurality of mobile devices.

30. The non-transitory processor-readable medium of claim 28 wherein the processor-readable instructions is further configured to cause the processor to:
obtain information corresponding to a plurality of transmitters on a plurality of points over a predetermined path;
determine local coordinates of the plurality of points using the position determination technique based at least on the obtained information and the set of local transmitter location information; and
determine the offset value by comparing the local coordinates of the plurality of points with one or more possible paths on a map.
